(19) United States
(12) Patent Application Publication
(10) Pub. No.: US 2013/0297384 A1
(43) Pub. Date: Nov. 7, 2013

(54) Systems, Methods, and Apparatus for Fashion and Apparel Color Forecasting

(71) Applicant: Coldwater Creek, Inc., Sandpoint, ID (US)

(72) Inventors: Farhan Patel, Sandpoint, ID (US); Sara McCann, Spokane, WA (US); J. Bailey Heckel, Hayden Lake, ID (US)

(21) Appl. No.: 13/830,892

(22) Filed: Mar. 14, 2013

Related U.S. Application Data
(62) Division of application No. 13/404,719, filed on Feb. 24, 2012.

(51) Int. Cl. G06Q 30/02

(52) U.S. Cl. CPC G06Q 30/0203
USPC 705/7.32

(57) ABSTRACT

This disclosure describes systems, methods, and apparatus for forecasting color preferences in clothing via electronic surveys transmitted to survey participants over the Internet. The electronic surveys present survey participants with families of colors and ask the survey participants whether they would wear clothing in any of the colors of a given family of colors. The surveys also ask which colors from each family survey participants would wear. The surveys also present survey participants with color choices in the context of specific types of clothing and seasons. The electronic surveys can also be used to predict preferred colors for use on products and services.

### CLAIM OF PRIORITY UNDER 35 U.S.C. §120

The present application for patent is a Divisional of patent application Ser. No. 13/404,719 entitled “SYSTEMS, METHODS, AND APPARATUS FOR FASHION AND APPAREL COLOR FORECASTING” filed Feb. 24, 2012, pending, and assigned to the assignee hereof and hereby expressly incorporated by reference herein.

### FIELD OF THE DISCLOSURE

The present invention relates generally to consumer preference forecasting. In particular, but not by way of limitation, the present invention relates to systems, methods and apparatuses for predicting preferred product colors and service-related colors.

### BACKGROUND

Clothing companies often rely upon color forecasting service companies to forecast color trends. These color trends are used to generate clothing color palettes for the retailers' upcoming seasons, but the accuracy is unproven due to the fast moving nature of the industry.

In part, this is because traditional color forecasting in the clothing industry is anything but a science. Color ‘experts’ travel to trade and fashion shows as well as markets, neighborhoods, and social centers, and anecdotally study color trends and preferences around the globe. What is more, these forecasts are made a few weeks to several months in advance, which further diminishes their accuracy.

Consumer surveys have been considered but not used since manageable representative sets of colors have not been identified and mailing hundreds of color swatches to thousands of customers is a prohibitively expensive process, labor intensive, and excessively time consuming. Moreover, even hundreds of color swatches would not be sufficient since there are millions of colors that would need to be surveyed every season. Online surveys have also been avoided due to concerns about color accuracy and consistency between the thousands of different computer monitors and mobile device displays that would be used to view online surveys.

### SUMMARY

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Some embodiments of the disclosure may be characterized as a method of generating a clothing color palette forecast. The method includes transmitting an electronic survey to a number of computing devices, where the electronic survey presents survey participants with a manageable set of colors via the computing devices. The method also includes receiving answered electronic surveys from the computing devices. The answered electronic surveys can include data evidencing color preferences associated with each of the survey participants. The method further includes generating a set of preferred color variation directions configured for use in generating a forecasting set of colors, where the set of preferred color variation directions is selected based on the data evidencing the color preferences of the survey participants.

Other embodiments of the disclosure may also be characterized as a non-transitory, tangible computer readable storage medium, encoded with processor readable instructions for surveying survey participants regarding preferred clothing colors. The non-transitory, tangible computer readable storage medium can include colors (or images of colors) including a family of colors selected from a manageable set of colors. The family of colors can comprise a base color and variations of the base color. The non-transitory, tangible computer readable storage medium can also include at least one color preference question related to the images of colors as well as an answer field corresponding to the color preference questions.

Other embodiments of the disclosure can be characterized as a non-transitory, tangible computer readable storage medium, encoded with processor readable instructions for surveying survey participants regarding preferred clothing colors. The storage medium can include at least one color preference question and an answer field providing a means for a survey participant to answer the at least one color preference question. The storage medium can also include images of colors for a family of colors comprising at least: a base color having a lightness, chroma, and hue; a first variation of the base color having greater lightness; a second variation of the base color having lesser lightness; a third variation of the base color having greater chroma; a fourth variation of the base color having lesser chroma; a fifth variation of the base color having greater hue; and a sixth variation of the base color having lesser hue.

Another embodiment of the disclosure can be characterized as a method of generating a clothing color palette forecast. The method can include transmitting an electronic survey to computing devices, where the electronic survey presents one or more survey participants with a manageable set of colors via the computing devices. The manageable set of colors may also comprise a plurality of color families, at least one of the color families including a base color and twelve variations of the base color. The twelve variations can include the following: a first variation of the base color having greater lightness; a second variation of the base color having lesser lightness; a third variation of the base color having greater chroma; a fourth variation of the base color having lesser chroma; a fifth variation of the base color having greater hue; a sixth variation of the base color having lesser hue; a seventh variation of the base color having greater lightness than the first variation; an eighth variation of the base color having lesser lightness than the second variation; a ninth variation of the base color having greater lightness than the third variation; a tenth variation of the base color having greater lightness than the fourth variation; an eleventh variation of the base color having greater lightness than the fifth variation; and a twelfth variation of the base color having greater lightness than the sixth variation. The method further includes receiving answered electronic surveys from the plurality of computing devices, where the answered electronic surveys include data evidencing color preferences for the survey participants in terms of preferred base colors, preferred variations of the preferred base colors, and colors that would be worn in different types of clothing and seasons. The method also generates a set of preferred color variation directions configured for use in generating a forecasting set of colors, where the set of preferred color variation directions is selected based on the data evidencing the color preferences of the survey participants.

Further embodiments of the disclosure can be characterized as a system having a first non-transitory, tangible computer readable storage medium, a communications system, a second non-transitory, tangible computer readable storage medium, and a processor. The first storage medium is configured to store an electronic survey designed to ascertain color preferences for products and services. The communications system is configured to transmit the electronic survey to computing devices and receive answered electronic surveys from the computing devices. The second storage medium is configured to store the answered electronic surveys. The processor is configured to generate the electronic survey, control transmission of the electronic survey, control receipt of the answered electronic surveys, and determine a set of preferred color variation directions based on the answered electronic surveys.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1 is a system 100 that forecasts consumer color preferences via online surveys.

FIG. 2 illustrates one embodiment of a family of colors.

FIG. 3 illustrates a graphical user interface (“GUI”).

FIG. 4 illustrates another graphical user interface.

FIG. 5 illustrates one method of forecasting clothing color preferences.

FIG. 6 illustrates another method of forecasting clothing color preferences.

FIG. 7 shows a diagrammatic representation of one embodiment of a machine in the exemplary form of a computer system within which a set of instructions for causing a device to perform any one or more of the aspects and/or methodologies of the present disclosure to be executed.

### DETAILED DESCRIPTION

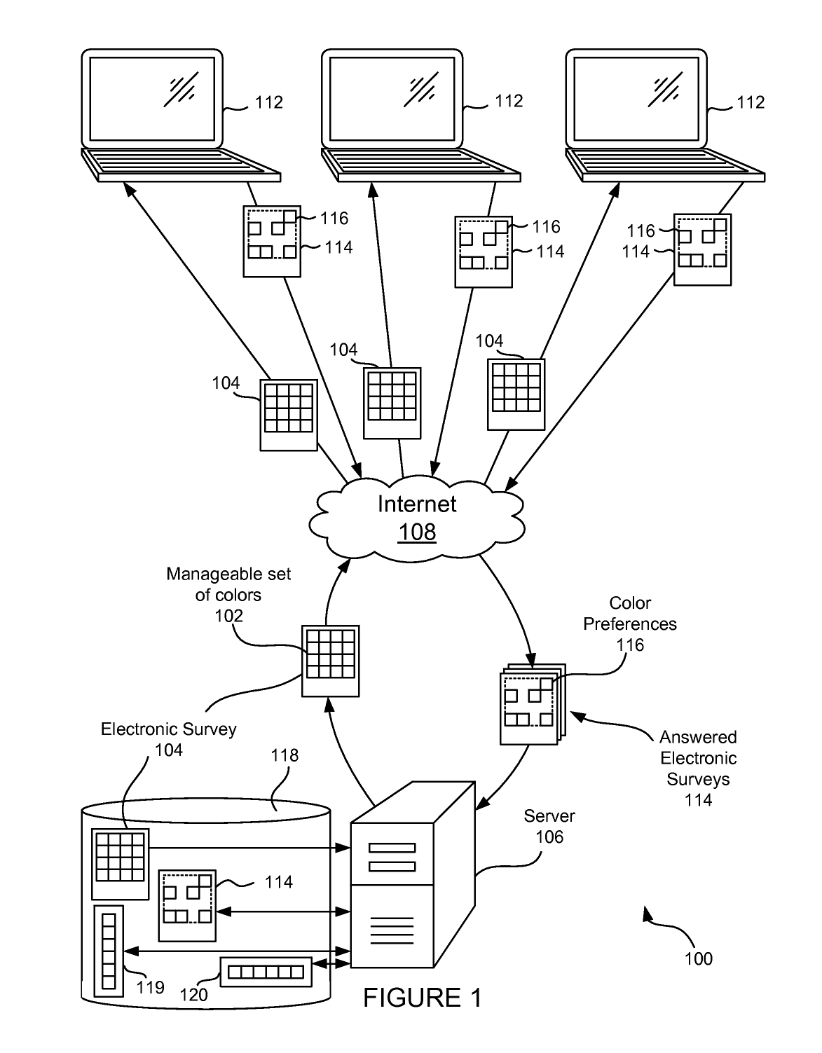

FIG. 1 is a system 100 that forecasts consumer color preferences via online surveys. The system 100 avoids the problems of mailing swatches to survey takers and collecting survey answers, by performing the survey online (e.g., via the Internet) and by surveying directions of color preference rather than specific color preferences. In particular, first survey participants are asked for preferences chosen from a base set of colors. The base set of colors can number from one to a few dozen. Second, survey participants are queried about preferences between variations of the preferred base colors in terms of color variation directions rather than absolute color preferences. As such, only a handful of variations need be presented to survey participants rather than thousands of variations. In other words, rather than ask for a consumer preference between a number of different shades of green, the survey asks whether a darker or lighter shade of green is preferred, and whether a redder or bluer shade of green is preferred. The final color forecast is then based on these directional preferences rather than actual colors selected by survey participants. Either a computing system running an algorithm can determine the final color forecast based on the directional preferences or a specialist in color analysis and forecasting can make this determination. In this way, a manageable number of colors can be shown to survey participants.

The issue of non-uniform color reproduction between displays is avoided since the inventor has discovered that most computer and mobile displays used by survey participants are of a type that reproduce colors in an accurate and consistent manner thus reducing traditional concerns about the accuracy of online color preference surveys.

Colors in the base set of colors can include, but are not limited to, red, green, blue, yellow, orange, white, black, brown, purple, and grey. Still further colors that can be included in a base set of colors include navy blue, olive green, burgundy, pink, magenta, and turquoise. On the other hand, it may not be desirable to use, for instance, two shades of green or two shades of grey as base colors since they may be so similar in that the different shades may appear identical on different displays.

The forecasting above described is performed by transmitting an electronic survey 104 to a plurality of computing devices 112 via the Internet 108. Survey participants access the electronic survey 104 and answer questions that indicate survey participants' color preferences. Those color preferences 116 are returned in answered electronic surveys 114. The color preferences 116 are analyzed and used to generate a forecasting set of colors 120 that are then used by or licensed to service companies (e.g., color consultants and product testing consultants), clothing and product manufacturers, and retailers to assist their clothing and product color selection.

The analysis of the color preferences 116 can be performed via a computing system, such as server 106, or via a human color specialist. The analysis can involve first tallying the answered electronic surveys 114 to determine total survey participant selections for each color of the color preferences 116. The result of this tallying can be a plurality of preferred color variation directions 119, where each preferred color variation direction is a color variation direction that received the most survey participant votes for a family of colors.

Each preferred color variation direction represents a preferred increase or decrease in lightness, chroma, and/or hue from a base color of a family of colors. For instance, if looking at the family of colors based on the base color blue, there will be one preferred color variation direction as indicated by the color variation that receives the most votes from survey participants for the blue color family. More specifically, given a base color having lightness=43, chroma=34, and hue=279, the preferred color variation might have lightness=43, chroma=34, and hue=284. This indicates that the preferred color variation direction is towards increased hue. There may not be an indication as to how much increased hue is preferred, and thus the color selected for the forecasting set of colors can be any color having lightness=43, chroma=34, hue>279. The ranked set of colors 119 presents suggested values for two of the three color values, while leaving the third value open for subjective selection. A computing system or a human color specialist can select this third value in order to select colors for the forecasting set of colors 120.

To determine survey participant's color preferences 116, the electronic survey 104 can present each user with one or more color preference questions directed to determining each survey participant's color preferences 116 as selected from the manageable set of colors 102. While only a single electronic survey 104 is illustrated, in some variations the electronic survey 104 can be tailored to individual survey participants such that more than one electronic survey 104 is transmitted via the Internet 108. The color preference questions can be presented along with an arbitrary arrangement of and subset of the manageable set of colors 102 via a graphical user interface (“GUI”). The manageable set of colors 102 can be made up of families of colors, each family including one base color and a number of variations on each respective base color. For instance, one family can be based on the base color red, and the family members can include variations of red such as lighter and darker reds, and greener and bluer reds. The one or more color preference questions can be presented to the survey participants along with a family of colors, the family being arbitrarily arranged on a GUI.

One exemplary color preference question can be directed to determining if the survey participant would wear any one or more of the colors in the survey on any type of clothing. Another color preference question can be directed to determining which colors the survey participants would wear. Yet another color preference question can be directed to determining during what season(s) the survey participant would wear a given color. Another color preference question can be directed to determining what type of clothing (e.g., pants, skirts, sweaters, tops, jackets, outerwear coat, dresses, and accessories) survey participants would wear in the displayed colors. Yet another color preference question can ask what a survey participant's favorite color is when selected from a family of colors (as compared to asking which colors the participant prefers). Another color preference question can be directed to determining what colors are preferably combined in an outfit (e.g., “If you were buying a cardigan sweater in the blue color above, which of the four colors above would you select for a top to layer under it?” or “If you were buying a cardigan sweater in the blue color above, would you select a top to layer under it of the same tonal color, a matching color, a contrasting color, or a shade of white?”). In another color preference question survey participants can indicate what types of clothing in a particular color they would wear together (e.g., “Which of the illustrated red sweaters would you consider to be an acceptable match to the illustrated red dress?”).

The electronic survey 104 can be season-dependent, for instance featuring different color families or different variations on a base color within each color family depending on the season. The types of clothing mentioned in the electronic survey 104 can also vary depending on the season. The electronic surveys 104 can also differ in complexity. For instance, some survey participants can be presented with a shorter version of the electronic survey 104 while other survey participants are presented with a longer version.

In one embodiment, the manageable set of colors 102 includes at least seven families of colors where the base color in each family is evenly separated from adjacent base colors in terms of hue. In other words, the at least seven colors have equal wavelength separation in the visible spectrum. In another embodiment, there are sixteen color families. In yet another embodiment, there are two hundred and three colors and sixteen color families in the manageable set of colors 102. In one embodiment, the base set of colors includes sixteen colors, for instance, purple, navy, blue, green, yellow, orange, red, grey, white, brown, olive, burgundy, pink, magenta, turquoise, and natural. In an embodiment, the base set of colors includes white and grey.

Colors can be defined by a variety of standards. For instance, color can be defined by color identification values for the following: lightness, chroma, and hue, where lightness represents a brightness of the color, chroma represents a color's degree of difference from grey, and hue represents the color (e.g., red, green, blue). Stated another way, lightness, chroma, and hue are the three dimensions of color attributes according to color physics and are represented by the acronym LCh. L stands from light [L, light, dark], C stands for chroma [C, dull, bright], and H stands for hue angle [h, red, green, blue, yellow]. See McDonalds, Rodericks. (1997) Color Physics for Industry, 2nd Ed. UK, Society of Dyers and Colorists, Publications. Each family can include six or twelve variations of the base color. Six variations can exist for instance where one has greater lightness, one has lesser lightness, one has greater chroma, one has lesser chroma, one has greater hue, and one has lesser hue. Twelve variations can also exist where the additional six variations (variations 7-12) each change one of, lightness, chroma, or hue, as compared to a respective one of the first six variations (variations 1-6). Five of the additional variations (variations 7-11) can each exhibit the same variation. For instance, they can each vary lightness, or they can each vary chroma, or they can each vary hue. The twelfth variation can have the opposite variation of the seventh through eleventh variations. For instance, where variations 7-11 have greater lightness than their respective variations 1-6, variation 12 can have lesser lightness than its respective variation in the variations 1-6.

In another embodiment, a first variation of the base color can have a greater lightness than the base color and a second variation can have less lightness than the base color. A third variation of the base color can have a greater chroma than the base color, and a fourth variation can have less chroma than the base color. A fifth variation of the base color can have a greater hue, and the sixth base color can have a lesser hue value than the base color hue. In other embodiments, the variations can be greater or fewer in number than six and can include more or less than one variation of the following: lightness, chroma, and hue. For instance, there can be four variations of hue—two greater and two lesser than the base color hue—or six variations of lightness—three greater and three lesser than the base color lightness.

Some families can include four variations of the base color. For instance, the white base color may only have four variations. Some families can include thirteen variations of the base color. For instance, the brown base color may have twelve variations, four each for lightness, chroma, and hue, plus one more variation. Some families can include fourteen variations of the base color. For instance, the green color may have fourteen variations, four each for lightness, chroma, and hue, plus two more variations. By selecting a base set of colors numbering between 9 and 16, and in having four to fourteen variations on each base color, a manageable set of colors is created such that the manageable set of colors 102 can be presented to survey participants without overwhelming them.

Although the colors herein disclosed are described in terms of lightness, chroma, and hue, other color identification systems can also be used. Lab Color Space or one of the International Commission on Illumination (CIE) color spaces are just two examples of other color identification standards. For instance, instead of families composed of a base color and variations having different lightness, chroma, or hue, a family may include a base color and variations having different X, Y, or Z (or x, y, or Y) coordinates from the base color, assuming use of the CIE 1931 color space.

The color preference questions can be independent or dependent. By dependent, it is meant that an answer to a first color preference question can determine whether a subsequent color preference question is presented and/or what type of subsequent color preference question is presented. For instance, a first color preference question can ask, “Would you wear any of these colors?” An affirmative answer can cause a second color preference question to be presented, such as, “Which of these colors would you wear.” Based on selections that the survey participant makes in response to the second color preference question, a third question may be presented, for instance, “Each of the colors you indicated you would wear are listed below, please mark if you would wear it as: . . . ” and then various types of clothing may be listed (e.g., pants, skirts, sweaters, etc.). A fourth question could further be presented such as, “Each of the colors you indicated you would wear are listed below, please mark if you would wear it in: Winter, Spring, Summer, Fall.”

The electronic survey 104 can be created and stored on a server 106, for instance via a storage medium such as a hard drive. In particular, the electronic survey 104 can be stored in a database 118 of the server 106. The electronic survey 104 can be transmitted via the Internet 108 to a plurality of computing devices 112 where users interact with the electronic survey 104. Computing devices 112 can include personal computers, desktop computers, laptop computers, tablet computers, and smartphones to name a few non-limiting examples. The electronic survey 104 can be transmitted as an e-mail, can be downloaded (e.g., via PDF or WORD document), or can be accessed via a website. In an embodiment, the electronic survey 104 is downloaded to a memory (short term or long term) of the computing devices 112. In another embodiment, the electronic survey 104 is not downloaded to a memory of the computing devices 112, but rather remains on the server 106 or some other remote computing device, but is accessed and modified by the computing devices 112 via the Internet. In yet another embodiment, the electronic survey 104 is stored on both the computing devices 112 and the server 106.

There may be more than one survey participant using each computing device 112. In this situation, the same or different electronic surveys 104 can be transmitted to the same computing device 112. In other words, the electronic survey 104 can be transmitted to a survey participant who can access the electronic survey 104 via any of the computing devices 112.

The survey participants' answers to the electronic survey 104 can be captured in color preferences 116, where the color preferences 116 can include a subset or all of the manageable set of colors 102. Either way, the color preferences 116 can also include an order of colors representative of the answers to the electronic survey 104. The answers, in the form of the color preferences 116, are returned via answered electronic surveys 114, which can be transmitted from each computing device 112 back to the server 106 via the Internet 108. The answered electronic surveys 114 can be stored on the database 118.

From the color preferences 116 a forecasting set of colors 120 can be selected where the forecasting set of colors 120 can be used by or licensed to clothing manufacturers or retailers to aid their selection of clothing colors for the current or future seasons. The forecasting set of colors 120 can include one or more of the colors in the manageable set of colors 102. In an embodiment, the forecasting set of colors 120 includes the entire manageable set of colors 102. In either embodiment, the forecasting set of colors 120 orders the colors in terms of user preference as determined via analysis of the answered electronic surveys 114.

The forecasting set of colors 120 can be generated via computational analysis of the color preferences 116 or via a subjective human determination (e.g., a color specialist's selection of a forecasting set of colors 120). Either way, the color preferences 116 can be used to determine color preference directions. Color preference directions can include a greater or lesser of any one or more of the following: lightness, chroma, hue. For instance, one color direction can be greater lightness given a certain chroma and hue. Another color direction can be a greater lightness and a lesser hue, given a certain chroma. In other words, color preference direction means that one or more of lightness, chroma, and hue are fixed while one or two of the other color values is defined merely as greater or lesser rather than a particular value. The color preference directions can then be used to determine the forecasting set of colors 120.

The forecasting set of colors 120 (or a palette) can include at least one color that is not selected from the manageable set of colors 102. In other words, the answered electronic surveys 114 can indicate both preferred base colors and preferred color direction variations relative to the base color (e.g., lighter, darker, greener, redder, etc.). Yet, instead of using the exact color variations in the manageable set of colors 102, the forecasting set of colors 120 may include a color not in the manageable set of colors 102, but one that is based on a direction of color variation and a number of survey participants that preferred the direction of color variation.

The computing devices can be Internet-connected, for instance via a local area network (LAN), Wi-Fi, cellular connection under the 3G or 4G standard, or any other means of connecting to the Internet. In particular, the computing devices merely access a website or receive an e-mail whereby the electronic survey can be accessed and completed.

The electronic survey 104, manageable set of colors 102, completed surveys 114, color preferences 116, and forecasting set of colors 120 are illustrated as having a particular shape and configuration. However, these are merely visual aids and not meant to be limiting or to represent any required shape or configuration. In particular, these elements are digital and therefore are not limited to any particular shape or configuration. Nor are the number of colors in the manageable set of colors 102, the color preferences 116, or the forecasting set of colors 120 intended to limit the number of colors that can be implemented in each of these elements.

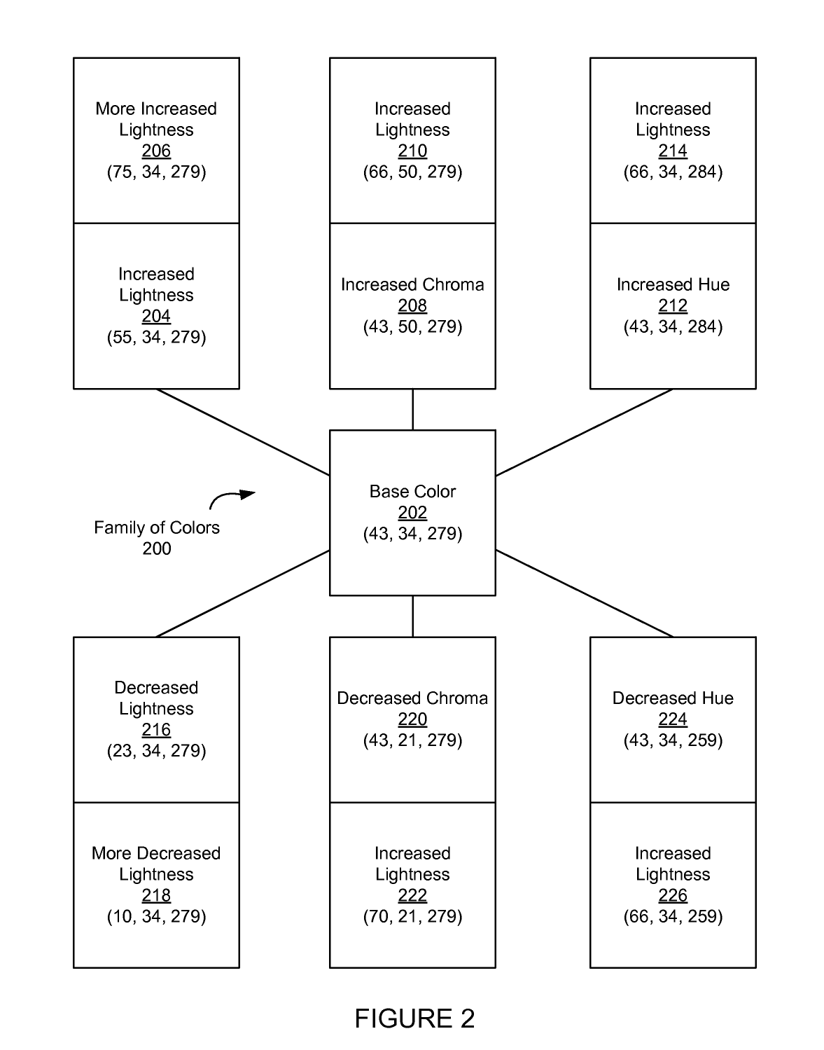

FIG. 2 illustrates one embodiment of a family of colors. The family of colors 200 includes a base color 202 and six (or optionally twelve) variations on the base color (or color variation directions). A first set of variations 204, 208, 212, 216, 220, 224 have more or less lightness, chroma, or hue than the base color 202, where these color identification values are indicated in parentheses as follows: (lightness, chroma, hue). These color identification values represent only a single exemplary color family, and many other families and variations within families are also envisioned. A lighter variation 204 has increased lightness and a more colorful variation 208 has increased chroma. A darker variation 216 has decreased lightness and a less colorful variation 220 has decreased chroma. Variations having a different hue than the base color 202, but having the same lightness and chroma, include a variation having greater hue 212 and a variation having lesser hue 224. Each of the first set of variations 204, 208, 212, 216, 220, 224 varies from the base color 202 in terms of one color identification value (lightness, chroma, or hue). For instance, the lighter variation 204 has increased lightness, but has the same chroma and hue as the base color 202. The variation having greater chroma, increased chroma 208, has increased chroma, but the same lightness and hue as the base color 202.

In a non-illustrated embodiment, one or more of the variations from the base color 202 can vary in terms of two or three of the three color identification values. For instance, a first variation can have increased lightness and increased hue as compared to the base color 202.

A second optional set of variations 206, 210, 214, 218, 222, 226 can have even more variation from the base color 202 than the first set of variations 204, 208, 212, 216, 220, 224. In particular, each color in the second set of variations 206, 210, 214, 218, 222, 226 can vary by one of, lightness, chroma, or hue, as compared to a respective one of the first set of variations 204, 208, 212, 216, 220, 224. For instance, more increased lightness variation 206 can have increased lightness as compared to the first increased lightness variation 204. It should be noted that the variations illustrated in the second set of variations 206, 210, 214, 218, 222, 226 all vary from their counterparts in the first set of variations 204, 208, 212, 216, 220, 224 in terms of lightness. However, in another embodiment, the variations in the second set of variations can vary from their counterparts in the first set of variations in terms of chroma. Alternatively, the variations in the second set of variations can vary from their counterparts in the first set of variations in terms of hue.

Chroma and hue are the same in the second set of variations 206, 210, 214, 218, 222, 226 as they were in the first set of variations 204, 208, 212, 216, 220, 224. However, each color in the second set of variations 206, 210, 214, 218, 222, 226 is not changed in the same fashion-five have increased lightness (206, 210, 214, 220, 224) while one has decreased lightness (216). This is because, when all six members of the second set of variations 206, 210, 214, 218, 222, 226 are varied by a particular color identification value (e.g., lightness, chroma, or hue), one of the variations in the second set 206, 210, 214, 218, 222, 226 will end up being very similar to the base color 202. As such, one of the six variations in the second set can be varied in an opposite direction to the other five. For instance, as illustrated, the second set 206, 210, 214, 218, 222, 226 all have increased lightness, except the more decreased lightness 218, which has more decreased lightness. If this variation were also increased in lightness, it would basically negate the effect of the decreased lightness 216 relative to the base color 202 and end up looking very similar to the base color 202. Hence, this variation 218 is changed in an opposite direction as the other five members of the second set 206, 210, 214, 218, 222, 226. This example shows that whether the second set 206, 210, 214, 218, 222, 226 is varied in the direction of increased or decreased lightness, chroma, or hue, one of the second set 206, 210, 214, 218, 222, 226 can be varied in the opposite direction of the other five colors in the second set 206, 210, 214, 218, 222, 226.

The variations 204, 206, 208, 210, 212, 214, 216, 218, 220, 222, 224, 226 are also known as color variation directions since they are not indicative of a preferred color so much as a preferred color variation (or directional variation) from the base color 202. For instance, the base color 202 may be green, and the decreased chroma variation 220 may be another shade of green. However, it is not the particular shade of green that this disclosure is concerned with, but rather the fact that it varies from the base color 202 in terms of decreased chroma 220. Based on this color variation direction, a color can be selected for a forecasting set of colors that is based on the base color 202, but having decreased chroma.

The forecasting set of colors can be selected based on one or more color variation directions receiving a greatest number of survey participant votes for a given family of colors. For instance, in FIG. 2, the increased lightness variation 210 might receive a greatest number of survey participant votes in the family 200 and could thus be used as a basis for selecting one color for the forecasting set of colors—any color having increased chroma and increased lightness as compared to the base color 202. The increased lightness variation 204 might receive the second most survey participant votes, and can thus also be the basis for selection of a color for the forecasting set of colors. It should be noted that while this example shows that one or two of the colors in the forecasting set of colors can be selected based on one or two preferred color variations, more than two color variations can also be the basis for more than two colors in the forecasting set of colors.

FIG. 2 should not be read as requiring that only lightness be changed in the second set, or that only an increase in one of the three color identification values be changed, or that the color in the second set 206, 210, 214, 218, 222, 226 corresponding to the decreased lightness 216 must have the opposite directional variation to the other five in the second set. Rather, many different combinations that are not illustrated are possible to one of skill in the art.

The actual lightness, chroma, and hue values of the base color 202 and the first and second sets of variations 204, 208, 212, 216, 220, 224, 206, 210, 214, 218, 222, 226 are not as important as the direction that the variations take relative to the base color 202. For instance, the direction of increased lightness or increased hue. These directional preferences are more important for forecasting than the actual lightness, chroma, and hue values of the colors since, by basing the forecasting on color variation direction rather than specific colors, a decreased number of color choices can be presented to users, and issues associated with color reproduction on different user displays is mooted.

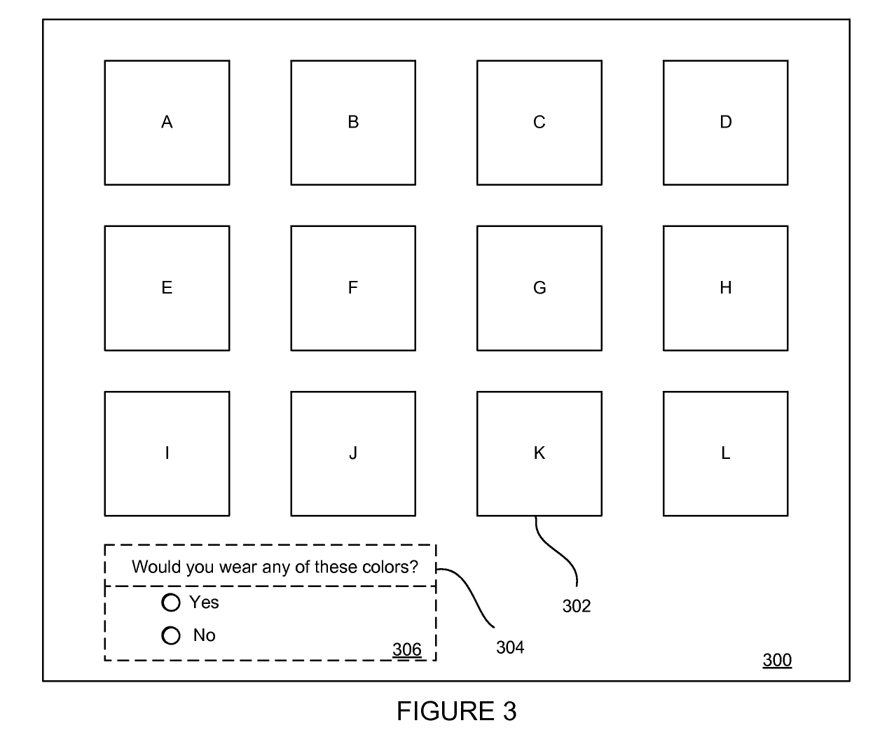

FIG. 3 illustrates a graphical user interface 300 (“GUI”). The first GUI 300 includes a plurality of color swatches 302, at least one color preference question 304 related to the plurality of color swatches 302, and selection objects 306 used by a survey participant to answer the at least one color preference question 304. In the illustrated embodiment, there are twelve color swatches in the plurality of color swatches 302, but more or less than twelve color swatches can also be used.

The plurality of color swatches 302 represent a family of colors, where the family includes a base color and variations of the base color. The plurality of color swatches 302 include all colors in a color family and are arbitrarily arranged relative to each other such that a viewer or survey participant cannot determine which color is the base color and which colors are variations. In other words, the variations are arbitrarily arranged relative to the base color. The color swatches can each include a number, letter, or some other unique identifier.

The at least one color preference question 304 can be directed to determining whether the survey participant would wear any one of the colors in the plurality of color swatches 302. For instance, the at least one color preference question 304 could say, “Would you wear any of these colors?”

The answer can be a yes or no answer although this is not required. The selection objects 306 can be arranged proximal to the at least one color preference question 304 and can include radio buttons (e.g., “Yes” and “No”) enabling the survey participant to indicate an answer to the at least one color preference question 304. A radio button allows only a single selection (e.g., yes or no) from a predefined set of selections. In comparison, selection boxes allow one or more selections to be made from a predefined set of selections. The selection objects 306 can also include text input fields, for instance allowing a survey participant to enter the text, “yes” or “no” or “maybe.” The selection objects 306 may also include number fields or some other selection mechanism allowing a survey participant to enter a range of values indicative of their level of preference for the family of colors 302 (e.g., “Rate your preference for these colors on a scale of 1-10”).

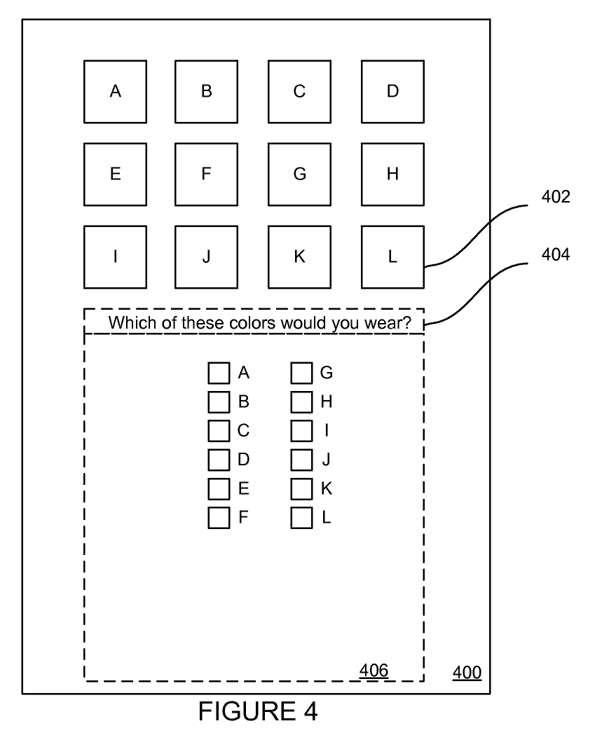

In an embodiment, when a survey participant selects the “Yes” radio button or otherwise indicates an affirmative answer to the at least one color preference question 304, a follow up question can be presented or a second GUI having the follow up question can become visible or replace the first GUI 300. For instance, if a survey participant indicates that they would wear one of the plurality of color swatches 302, then the GUI 300 can present the user with a follow up question asking which of the plurality of color swatches 302 the survey participant would wear (see FIG. 4).

Additionally, the follow up question may be directed to specific types of clothing, for instance whether the survey participant would wear any of the colors 302 in a shirt or dress. Alternatively, the follow up question can first address which colors the survey participant prefers and then raise another follow up question asking about what types of clothing the survey participant would wear in the preferred colors.

FIG. 4 illustrates another graphical user interface 400. This second GUI 400 could include the follow up question referenced in the description of FIG. 3. For instance, once the survey participant indicates a willingness to wear at least one of the colors presented in the plurality of color swatches 302 of the first GUI 300, the second GUI 400 can present at least one color preference question 404 regarding which of the colors in the plurality of color swatches 402 the survey participant prefers. The plurality of color swatches 402 can be the same colors of the plurality of color swatches 302 in FIG. 3. The second GUI 400 can also include selection objects 406, for instance, including selection boxes, one corresponding to each of the colors in the plurality of color swatches 402, where the survey participant can select one or more of the selection boxes. Although the depicted selection boxes in the selection objects 306, 406 are depicted as simple square boxes, the selection boxes may be realized by a variety of shapes, sizes, colors, or have other aesthetic properties.

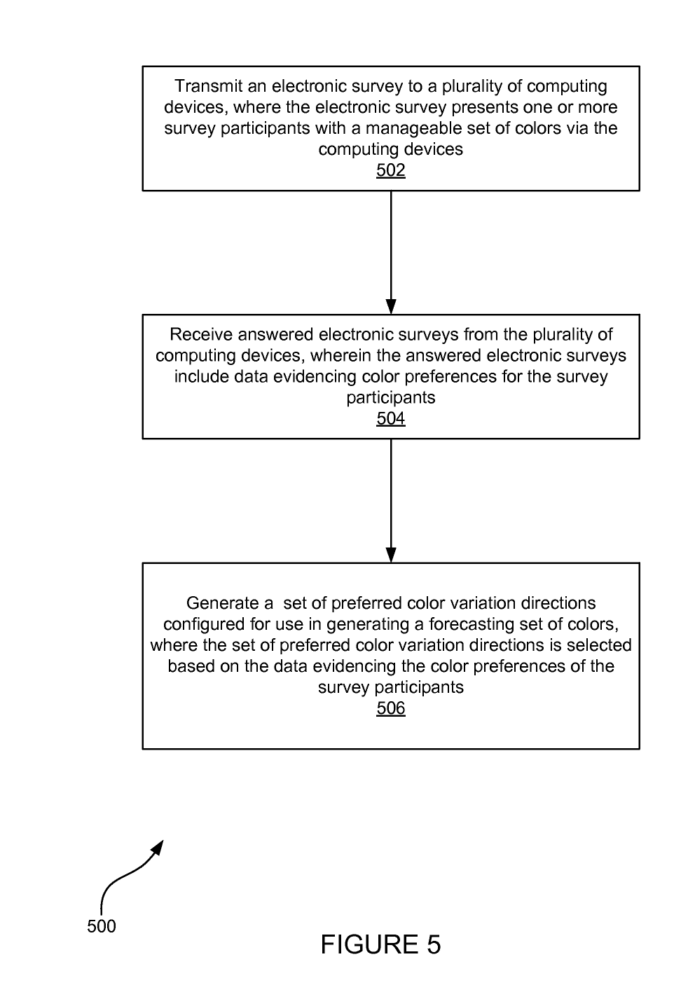

FIG. 5 illustrates one method 500 of forecasting clothing color preferences. The method 500 includes a transmit operation 502, a receive operation 504, and a generate operation 506. The transmit operation 502 transmits an electronic survey (e.g., the electronic survey 104) to a plurality of computing devices.

The electronic survey transmitted in the transmit operation 502 presents users of the computing devices, or survey participants, with a manageable set of colors (e.g., the manageable set of colors 102) and questions regarding preferred colors selected from the manageable set of colors. The manageable set of colors can include a number of color families, for instance twelve color families. The questions can include questions such as, “Would you wear any of these colors,” and “Which of these colors would you wear.” The questions can also relate to user preference for colors within the context of certain clothing types. The survey participants can then answer the questions and return the electronic surveys (e.g., the answered electronic survey 114) via the Internet.

The answered electronic surveys are received from a plurality of computing devices (e.g., the plurality of computing devices 112) in receive operation 504. Each answered electronic survey can include color preferences (e.g., color preferences 116), or data describing color preferences, selected from the manageable set of colors. The answered electronic surveys can be received by a server (e.g., server 106) or other computing device configured to store the answered electronic surveys and or a server or computing device that originally transmitted the electronic survey.

The color preferences or data are then used to generate a forecasting set of colors (e.g., the forecasting set of colors 120) in the generate forecasting set of colors operation 506. The forecasting set of colors can include an ordered set of one or more of the manageable set of colors where the order of the ordered set is based on the data evidencing the color preferences of the survey participants. In other words, the forecasting set of colors can include a list of colors in order of survey participant preference, and can also be arranged in terms of clothing types or can have different sets of ordered colors, each set corresponding to a different clothing type. The forecasting set of colors may also have sets of colors arranged in color groups representing preferred combinations of colors. The forecasting set of colors can then be used or licensed by clothing companies to select their clothing colors for the current or upcoming season.

In one embodiment, the electronic surveys can also be used to test a current season's clothing color palette. Typically, sales receipts and customer surveys are used to analyze a season's clothing colors, but this typically occurs after the end of the season. Via the electronic surveys herein disclosed however, color preferences for a current season's color palette can be surveyed during the sales season to obtain a more real-time understanding of a color palette's success. The method 500 depicted in FIG. 5 can be modified to handle such in-season surveys by replacing the typical seven or more families of colors and their variations, with colors selected from the current season's color palette. The questions and other operations of the method 500 can otherwise remain the same.

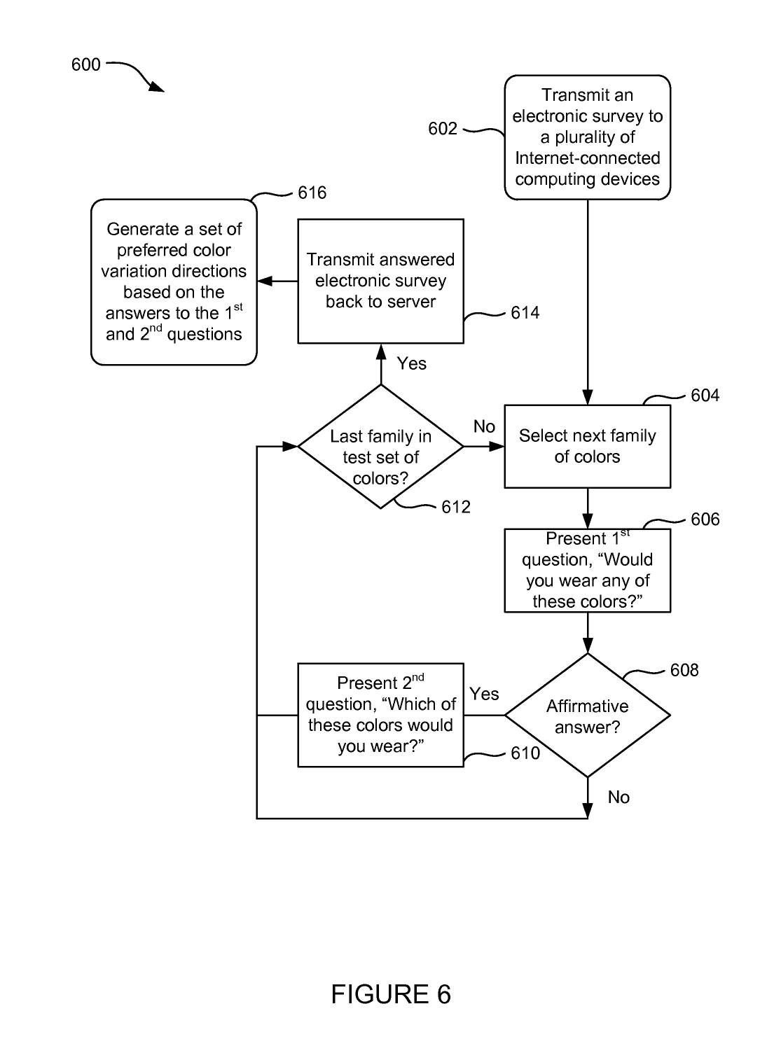

FIG. 6 illustrates another method 600 of forecasting clothing color preferences. Generally, the method 600 involves transmitting an electronic survey to a plurality of Internet-connected computing devices, presenting survey participants with the electronic survey to determine their color preferences and color preferences relative to different types of clothing, receiving answered electronic surveys documenting these color preferences, and generating a forecasting set of colors based on the answered electronic surveys. The forecasting set of colors can then be used or licensed by clothing retailers to select their clothing colors for the current or for a future sales season.

The method 600 accomplishes the above by first transmitting an electronic survey to a plurality of computing devices in a transmit electronic survey operation 602. The transmit electronic survey operation 602 can obtain the electronic survey from an electronic storage medium such as the hard drive of one or more servers. The computing devices can include personal computers and mobile devices, to name just two non-limiting examples, and can be connected to the Internet via wired or wireless links.

Once the survey participant accesses the electronic survey, the method 600 can select a next family of colors from a manageable set of colors in a select next family of colors operation 604. In the case of the first family of colors, the select next family of colors operation 604 can select the first family of colors. The method 600 can then present the survey participant with a first question in a present first question operation 606. One exemplary first question is, “Would you wear any of these colors?” There is no intention to limit the scope of the invention to this particular question—rather this question is merely exemplary. The first question can be presented in conjunction with the first family of colors and a selection or answer field enabling the survey participant to select a “yes” or “no” answer (e.g., see FIG. 3).

The first decision 608 determines whether the survey participant answered the first question in the affirmative (e.g., by selecting “yes”). If yes, then the method 600 can present a second question to the survey participant relative to the same family of colors in a second present operation 610. In an embodiment, the same color swatches can continue to be displayed for the survey participant along with the second question. An exemplary second question is, “Which of these colors would you wear?” The second question can be presented along with a selection or answer field that includes a number of answer choices and the ability for the survey participant to select more than one answer. For instance, the survey participant may be able to select each color in the family that they would wear. In other words, the survey participant can select between one and all of the colors in the family. Alternatively, the question may ask for the survey participant's top three colors and enable only three answer selections to be made. Once the second question is presented, the method 600 moves to the second decision 612.

If the survey participant did not answer affirmatively to the first question, then the second question is not presented, but rather the method 600 moves straight to the second decision 612. The second decision 612 determines whether the color family presented to the survey participant is the last color family in the manageable set of colors. This second decision 612 is made whether the first question was answered in the affirmative or not. If not, then the method 600 repeats the select next family of colors operation 604, the present first question operation 606, the first decision 608, possibly the present second question operation 610, and the second decision 612. When this cycle has repeated such that each family of colors in the manageable set of colors has been presented to the survey participant, the decision 612 turns the method 600 to the transmit answered electronic survey back to server operation 614 where the answered electronic survey is transmitted via the Internet back to the server.

The server receives the answered electronic surveys from the plurality of computing devices, or at least all of those where survey participants completed the electronic survey. The answered electronic surveys are then tallied to generate a set of preferred color variation directions in generate a set of preferred color variation directions operation 616. The preferred color variation directions can be selected based on the answers to the first and second questions.

The set of preferred color variation directions can then be used to generate a forecasting set of colors. The forecasting set of colors can be selected based on the set of preferred color variation directions, where the colors in the forecasting set of colors vary from a base color in the same fashion that the preferred color variation directions vary. For instance, where the base color is green, and the preferred color variation direction for the family of colors surrounding green was increased chroma, the shade of green selected for the forecasting set of colors can have any chroma value greater than the base color green.

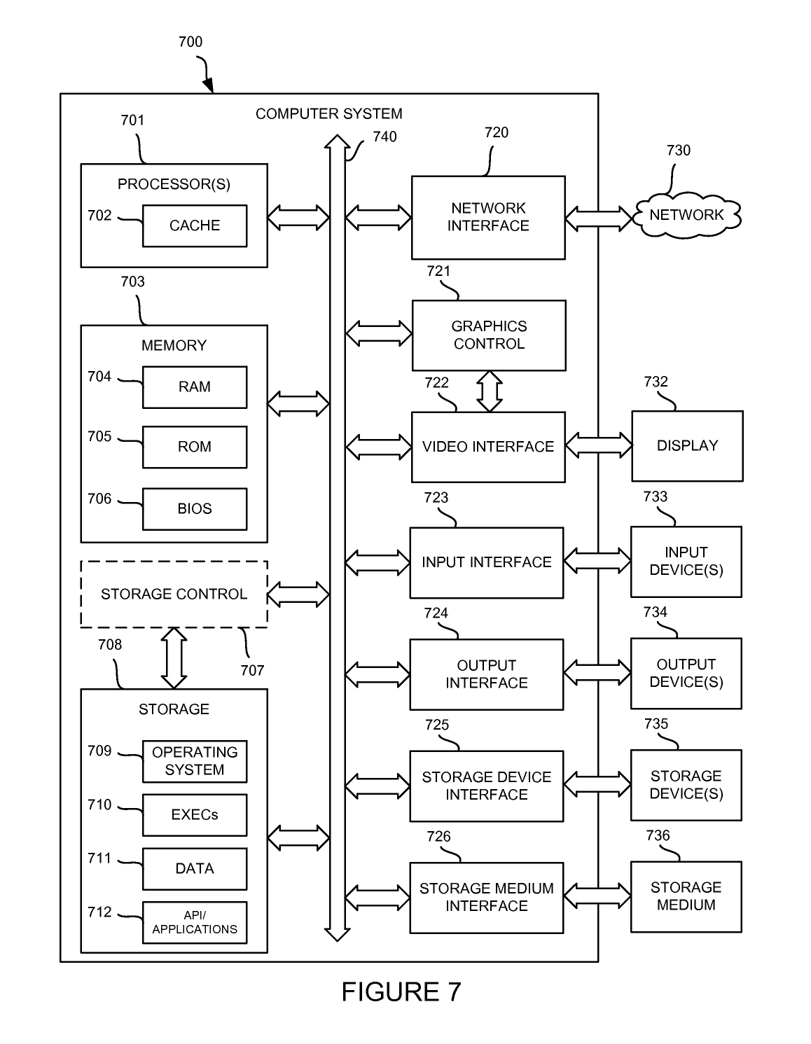

The systems and methods described herein can be implemented in a machine such as a computer system in addition to the specific physical devices described herein. FIG. 7 shows a diagrammatic representation of one embodiment of a machine in the exemplary form of a computer system 700 within which a set of instructions can execute for causing a device to perform or execute any one or more of the aspects and/or methodologies of the present disclosure. The components in FIG. 7 are examples only and do not limit the scope of use or functionality of any hardware, software, embedded logic component, or a combination of two or more such components implementing particular embodiments.

Computer system 700 may include a processor 701, a memory 703, and a storage 708 that communicate with each other, and with other components, via a bus 740. The bus 740 may also link a display 732, one or more input devices 733 (which may, for example, include a keypad, a keyboard, a mouse, a stylus, etc.), one or more output devices 734, one or more storage devices 735, and various tangible storage media 736. All of these elements may interface directly or via one or more interfaces or adaptors to the bus 740. For instance, the various tangible storage media 736 can interface with the bus 740 via storage medium interface 726. Computer system 700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 701 (or central processing unit(s) (CPU(s))) optionally contains a cache memory unit 702 for temporary local storage of instructions, data, or computer addresses. Processor(s) 701 are configured to assist in execution of computer readable instructions. Computer system 700 may provide functionality as a result of the processor(s) 701 executing software embodied in one or more tangible computer-readable storage media, such as memory 703, storage 708, storage devices 735, and/or storage medium 736. The computer-readable media may store software that implements particular embodiments, and processor(s) 701 may execute the software. Memory 703 may read the software from one or more other computer-readable media (such as mass storage device(s) 735, 736) or from one or more other sources through a suitable interface, such as network interface 720. The software may cause processor(s) 701 to carry out one or more processes or one or more steps of one or more processes described or illustrated herein. Carrying out such processes or steps may include defining data structures stored in memory 703 and modifying the data structures as directed by the software.

The memory 703 may include various components (e.g., machine readable media) including, but not limited to, a random access memory component (e.g., RAM 704) (e.g., a static RAM “SRAM”, a dynamic RAM “DRAM, etc.), a read-only component (e.g., ROM 705), and any combinations thereof. ROM 705 may act to communicate data and instructions unidirectionally to processor(s) 701, and RAM 704 may act to communicate data and instructions bidirectionally with processor(s) 701. ROM 705 and RAM 704 may include any suitable tangible computer-readable media described below. In one example, a basic input/output system 706 (BIOS), including basic routines that help to transfer information between elements within computer system 700, such as during start-up, may be stored in the memory 703.

Fixed storage 708 is connected bidirectionally to processor(s) 701, optionally through storage control unit 707. Fixed storage 708 provides additional data storage capacity and may also include any suitable tangible computer-readable media described herein. Storage 708 may be used to store operating system 709, EXECs 710 (executables), data 711, APV applications 712 (application programs), and the like. Often, although not always, storage 708 is a secondary storage medium (such as a hard disk) that is slower than primary storage (e.g., memory 703). Storage 708 can also include an optical disk drive, a solid-state memory device (e.g., flash-based systems), or a combination of any of the above. Information in storage 708 may, in appropriate cases, be incorporated as virtual memory in memory 703.

In one example, storage device(s) 735 may be removably interfaced with computer system 700 (e.g., via an external port connector (not shown)) via a storage device interface 725. Particularly, storage device(s) 735 and an associated machine-readable medium may provide nonvolatile and/or volatile storage of machine-readable instructions, data structures, program modules, and/or other data for the computer system 700. In one example, software may reside, completely or partially, within a machine-readable medium on storage device(s) 735. In another example, software may reside, completely or partially, within processor(s) 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 700 may also include an input device 733. In one example, a user of computer system 700 may enter commands and/or other information into computer system 700 via input device(s) 733. Examples of an input device(s) 733 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In particular embodiments, when computer system 700 is connected to network 730, computer system 700 may communicate with other devices, specifically mobile devices and enterprise systems, connected to network 730. Communications to and from computer system 700 may be sent through network interface 720. For example, network interface 720 may receive incoming communications (such as requests or responses from other devices) in the form of one or more packets (such as Internet Protocol (IP) packets) from network 730, and computer system 700 may store the incoming communications in memory 703 for processing. Computer system 700 may similarly store outgoing communications (such as requests or responses to other devices) in the form of one or more packets in memory 703 and communicated to network 730 from network interface 720. Processor(s) 701 may access these communication packets stored in memory 703 for processing.

Examples of the network interface 720 include, but are not limited to, a network interface card, a modem, and any combination thereof. Examples of a network 730 or network segment 730 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 730, may employ a wired and/or a wireless mode of communication. In general, any network topology may be used.

Information and data can be displayed through a display 732. Examples of a display 732 include, but are not limited to, a liquid crystal display (LCD), an organic liquid crystal display (OLED), a cathode ray tube (CRT), a plasma display, and any combinations thereof. The display 732 can interface to the processor(s) 701, memory 703, and fixed storage 708, as well as other devices, such as input device(s) 733, via the bus 740. The display 732 is linked to the bus 740 via a video interface 722, and transport of data between the display 732 and the bus 740 can be controlled via the graphics control 721.

In addition to a display 732, computer system 700 may include one or more other peripheral output devices 734 including, but not limited to, an audio speaker, a printer, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition or as an alternative, computer system 700 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Color information can be input into the computer system 700 for instance via manual data entry on input device 733 or via data transfer on network 730 or as saved data in the storage device (e.g., flash drive) 735. In one embodiment, an input device 733, such as a spectrophotometer (not illustrated), can capture color information from tangible objects or color sources and the color information can be stored on the computer system 700, for instance in the memory 703 or storage 708. In an alternative embodiment, any computer assisted design (CAD) program can generate colors and their associated color information.

In conclusion, the present invention provides, among other things, a method, system, and apparatus that forecasts color preferences in clothing based on electronic surveys provided to survey participants via the Internet. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. For instance, while the disclosure largely discusses color preferences in the clothing industry, the same systems, methods, and apparatus can be applied to forecasting color preferences for other products (e.g., cell phone skins, car bodies, home interior paint schemes) as well as services (e.g., website design, company logos, fleet vehicle colors, uniforms). Many other variations, modifications, and alternative constructions also fall within the scope and spirit of the disclosed invention.

1-4. (canceled)

5. A non-transitory, tangible computer readable storage medium, encoded with processor readable instructions for surveying survey participants regarding preferred clothing colors comprising:
at least one color preference question;
an answer field providing a means for a survey participant to answer the at least one color preference question;
images of colors for a family of colors comprising at least:
a base color having a lightness, chroma, and hue;
a first variation of the base color having greater lightness;
a second variation of the base color having lesser lightness;
a third variation of the base color having greater chroma;
a fourth variation of the base color having lesser chroma;
a fifth variation of the base color having greater hue; and
a sixth variation of the base color having lesser hue.

6. The non-transitory, tangible computer readable storage medium of claim 5, further comprising a seventh variation of the base color having greater or lesser lightness, chroma, or hue than one of the first through sixth variations of the base color.

7. The non-transitory, tangible computer readable storage medium of claim 6, further comprising additional variations of the base color that have the same greater or lesser variation as the seventh variation, where the greater or lesser variation is selected from the group consisting of: lightness, chroma, and hue.

8. The non-transitory, tangible computer readable storage medium of claim 6, further comprising another variation of the base color having an opposite greater or lesser lightness, chroma, or hue than the seventh variation.

9. The non-transitory, tangible computer readable storage medium of claim 5, further comprising two color preference questions.

10. The non-transitory, tangible computer readable storage medium of claim 9, wherein the two color preference questions ask:
whether a survey participant would wear clothing in a color selected from the family of colors; and
which of the colors in the family of colors the survey participant would wear.

11. (canceled)

12. A system comprising:
a first non-transitory, tangible computer readable storage medium configured to store an electronic survey, the electronic survey designed to ascertain color preferences for products and services;
a communications system configured to transmit the electronic survey to computing devices and receive answered electronic surveys from the computing devices;
a second non-transitory, tangible computer readable storage medium configured to store the answered electronic surveys; and
a processor configured to:
generate the electronic survey;
control transmission of the electronic survey;
control receipt of the answered electronic surveys; and
determine a set of preferred color variation directions based on the answered electronic surveys.

13. A system for generating a clothing color palette forecast comprising:
a communications system configured to:
transmit an electronic survey to computing devices, where the electronic survey presents survey participants with a manageable set of colors via the computing devices;
receive answered electronic surveys from the computing devices, wherein the answered electronic surveys include data evidencing color preferences for the survey participants; and
a processor configured to generate a set of preferred color variation directions, the preferred color variation directions configured for use in generating a forecasting set of colors, where the set of preferred color variation directions is selected based on the data evidencing the color preferences of the survey participants.

14. The system of claim 13, wherein the electronic surveys ask whether a survey participant would wear any colors from the manageable set of colors.

15. The system of claim 13, wherein the electronic surveys ask which colors from the manageable set of colors a survey participant would wear.

16. The system of claim 13, wherein the manageable set of colors includes a base color and a plurality of variations on the base color.

17. The system of claim 16, wherein the plurality of variations on the base color are arbitrarily arranged relative to the base color.

18. The system of claim 16, wherein each of the plurality of variations on the base color differ from the base color in one or more of the following: lightness, chroma, and hue.

19. The system of claim 13, wherein the electronic surveys present the survey participants with a base set of colors that is a subset of the manageable set of colors.

20. The system of claim 19, wherein the manageable set of colors comprise two or more families of colors, where each family of colors comprise:
a base color selected from the base set of colors; and
color variation directions, which are variations of the base color.

21. The system of claim 13, wherein each of the preferred color variation directions is selected as a color variation direction receiving a greatest number of survey participant votes for a respective family of colors.

22. (canceled)
